(19) United States
(12) Patent Application Publication
(10) Pub. No.: US 2020/0226514 A1
(43) Pub. Date: Jul. 16, 2020

(54) INTELLIGENT MEETING AND TIME MANAGEMENT SYSTEM AND METHOD

(71) Applicant: JPMorgan Chase Bank, N.A., New York, NY (US)

(72) Inventors: Michelle Y. Zheng, New York, NY (US); Ana Ostojic, New York, NY (US); Chelsea Tinslay, Sunnyside, NY (US); Erin Monahan, New York, NY (US); Lisa K. Soukup, Dublin, OH (US)

(21) Appl. No.: 15/235,147

(22) Filed: Aug. 12, 2016

(51) Int. Cl. G06Q 10/06; G06F 17/30; H04L 29/06

(52) U.S. Cl. CPC G06Q 10/06311; H04L 65/403; G06F 17/30864

(57) ABSTRACT

Embodiments of the claimed invention are drawn to systems and methods seamlessly managing a meeting, comprising an appointment interface displayed on a computing device wherein a user selects one or more recipients to receive a meeting request, inputs a location, time, and subject for the meeting. Embodiments of the claimed invention are also drawn to systems and methods of seamlessly managing commitments, comprising a commitment interface displayed on a computing device, wherein a user ascertains their commitments on a combination of priority, time to complete the task, and deadline.

### FIELD OF THE INVENTION

Embodiments of the invention are related systems and methods for seamlessly managing a meeting. Further embodiments of the invention relate to systems and methods for seamlessly managing tasks and commitments.

### BACKGROUND OF THE INVENTION

Company mail and calendar applications (or software) are used for managing emails, organizing meetings, tabulating tasks, tracking content, and planning schedules, amongst various other uses. These applications, however, are often limited in functionality and not integrated with a company's other internal services. For example, in the conventional method of reserving a room in a company's facility, an employee requests and reserves a room based on an estimated number of people in attendance, and separately creates the appointment in the company's calendar application and sends an invite with the reserved room to colleagues. Often the room is improperly sized for the actual number of attendees who R.S.V.P., and thus needs to be changed. To conserve company resources, a different room is then usually reserved, and the calendar invite is updated. Even further, any food or beverages associated with the meeting need to be ordered separately, often ending up in the wrong room, with an incorrect amount ordered. This is time consuming, inefficient, and often leads to errors and stress.

Additionally, in today's global marketplace, online meetings have become very popular. However, tracking attendance for meetings where the attendee will attend online versus in-person, ensuring that appropriate copies of relevant documents are available at the in-person meeting location, and generally ensuring a glitch-free meeting requires a lot of preparation and coordination from a company's information technology group, event management group, the meeting organizer etc. This process takes valuable time away from the meeting organizer to adequately prepare for the substantive content of the meeting. Many of the functions of stock mail and calendar applications are difficult to find and use.

Furthermore, task management has become increasingly difficult. When a recipient receives an e-mail containing a task, they often have to assess the priority of the task, and whether they have time to complete it timely. Often, the recipient overpromises or underpromises, and may put themselves in a position to have to work overtime, or alternatively, may miss their deadline. Furthermore, they're unable to properly visualize the exact time in their schedule they can (and should) allot to a particular task.

Other drawbacks also exist. Accordingly, the inventors recognized a need in the art for an intelligent calendar and mail application that streamlines the process of managing meetings, tasks/commitments and mail.

### SUMMARY OF THE INVENTION

Embodiments of the invention are generally related to meeting management, and specifically systems and methods for seamlessly managing a meeting. Further embodiments of the invention relate to systems and methods for seamlessly managing tasks and commitments.

Embodiments of the claimed invention are drawn to server-based meeting management system for seamlessly managing a meeting, comprising an appointment interface displayed on a computing device wherein a user selects one or more recipients to receive a meeting request, inputs a location, time, and subject for the meeting. The system comprises a nontransitory computing memory including a people database for storing the contact information of the one or more recipients, and a location database for storing the location information of the one or more recipients of a meeting invite. The system also comprises a meeting processor for receiving the inputted location for the meeting and accessing the location database for creating at least one of a map or blueprint and displaying directions for the recipient to the meeting location, wherein map and/or blueprint is interactive.

Embodiments of the claimed invention are also drawn to computer-implemented methods for seamlessly managing a meeting wherein a user inputs into an appointment interface displayed on a computing device, one or more recipients to receive a meeting request, a location, time, and subject for the meeting. The method of storing, in a nontransitory computing memory, the contact information of the one or more recipients in a people database, and the location information of the one or more recipients of a meeting invite in a location database. The method also processes the received inputted location for the meeting and accesses the location database for creating at least one of a map or blueprint and displaying directions for the recipient to the meeting location, wherein the map and/or blueprint is interactive.

Embodiments of the invention are drawn to a server-based management system for managing commitments comprising a server with a nontransitory computer memory storing instructions, a database for tasks, and processors to process priority, time, and deadlines. Embodiments of the claimed invention, for each task, also transmit to a user device, the assigned priority, time, and deadline, and displaying the assigned priority, time, and deadline on a commitment interface.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be exemplary only.

FIG. 1 is a block diagram of an appointment interface in accordance with an embodiment of the present invention.

FIG. 2 is a block diagram of an appointment interface in accordance with an embodiment of the present invention.

FIG. 3 is a block diagram of an appointment interface in accordance with an embodiment of the present invention.

FIG. 4 is a block diagram of a weekly meeting view in accordance with an embodiment of the present invention.

FIG. 5 is a block diagram of a weekly meeting view in accordance with an embodiment of the present invention.

FIG. 6 is a block diagram of a weekly meeting view in accordance with an embodiment of the present invention.

FIG. 7 is a block diagram of an attendee's interface in accordance with an embodiment of the present invention.

FIG. 8 is a block diagram of a meeting management system in accordance with an embodiment of the present invention.

FIG. 9 is a block diagram of a user device in accordance with an embodiment of the present invention.

FIG. 10 is a flow diagram illustrating an intelligent meeting management method in accordance with an embodiment of the present invention.

FIG. 11 is a block diagram of a commitment management system in accordance with an embodiment of the present invention.

FIG. 12 is a block diagram in of a commitment management system in accordance with an embodiment of the invention.

FIG. 13 is a block diagram of a weekly commitment view in accordance with an embodiment of the invention.

### DETAILED DESCRIPTION OF THE INVENTION

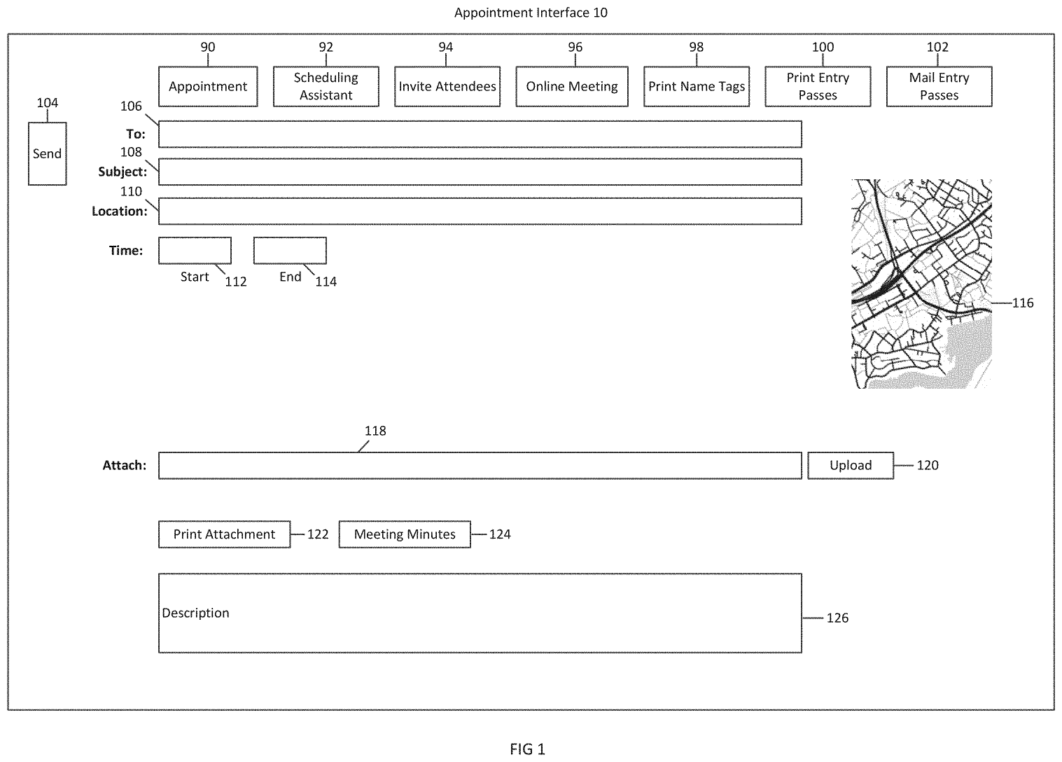

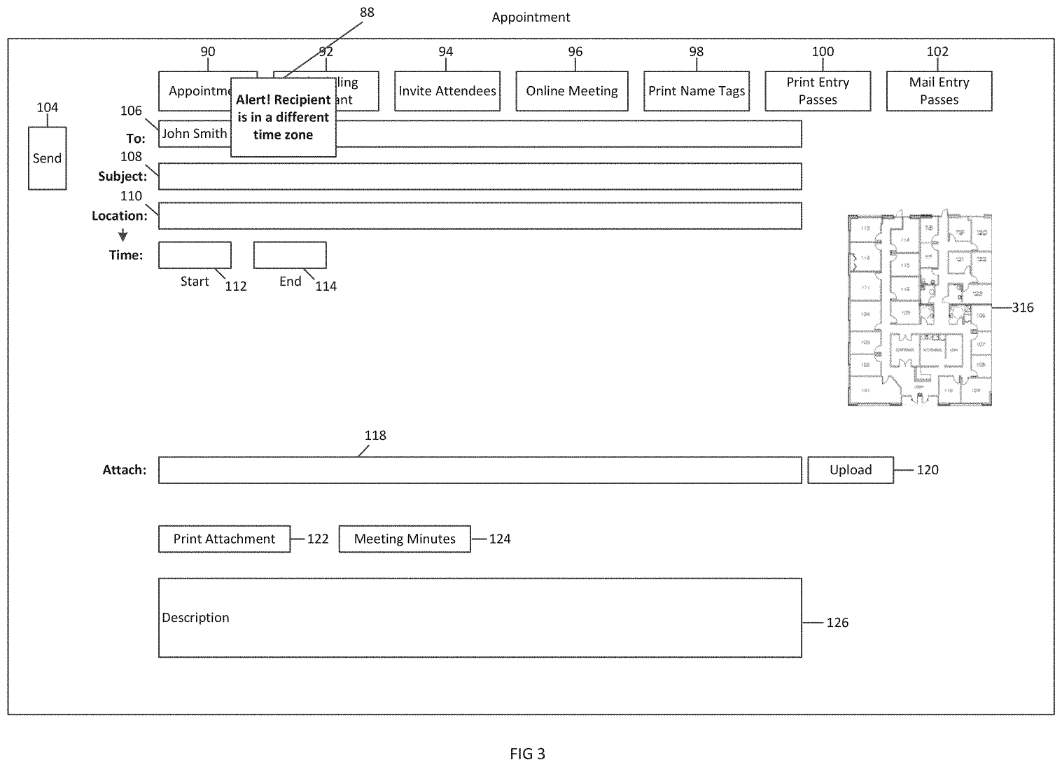

FIGS. 1, 2, and 3 are depictions of embodiments of an appointment interface. In embodiments of the invention, a sender, often an employee of a company, may utilize the appointment interface 10 to send a meeting request to a recipient by clicking the invite attendees 94 button and entering one or more recipients' names into the to field 106. The recipient may be another employee of the organization, a contact in the employee's address book, or any person or entity with a phone number, e-mail address, or physical mailing address. In embodiments of the invention, the smart meeting management system 40 will automatically group recipients. For example, if a meeting title is associated with the same recipients, those recipients will automatically populate if a sender starts typing the same meeting title. This can be based on the history of that meeting, or the previous meeting. Recipients may also automatically populate based on, for example, the project, the sender, or the client. As depicted in FIG. 3, in certain embodiments of the appointment interface 10 an alert 88 populates when the sender is inviting one or more recipients to the meeting, wherein one or more recipients is in a different time zone. In embodiments of the invention, the time zone of the meeting will be the time of the sender. In other embodiments, the time zone will be the time zone of most recipients. The time zone may be manually or automatically set. A sender may send the appointment or meeting request by clicking the send 104 button.

The sender may add a subject to the meeting by entering text, an image file, an audio file, or a video file into the subject field 108. In embodiments of the invention, the sender may ascertain the best time for the meeting using a company's scheduling assistant 92. A sender may input any description into the description box 126. The description can be text, image, audio, video, or any other cognizable input. In embodiments of the invention, if the description in the description box 126 mentions an attachment where no attachment was uploaded, an alert may pop-up for the sender to be reminded of the attachment. A user may customize the buttons on the appointment interface 10 to serve their needs, and the processors containing the appointment interface 10 will scan the buttons and the descriptions and ensure the sender is not missing a key component. For example, if the sender adds a button for mailing entry passes, the appointment interface 10 will remind the user to specify recipients who must receive the entry passes.

The sender may specify a location by entering a room within the company's office building, an address, or an otherwise cognizable location into the location field 110. In embodiments of the invention, a room can be an assigned office, or their choice seating. For example, where employees do not have assigned seats, they may choose where to sit in the building. In embodiments of the invention, an employee can ascertain where to sit based on who has already checked in and chosen their seat for the day/hour/month, etc. In embodiments of the invention, if an address is inputted into the location field 110, a map 116 disclosing the address location may populate. The map 116 may optionally have traffic components, whereby a user is able to ascertain the traffic patterns of a route they would take to attend the meeting. Depending on when the user views the map 116, the traffic may indicate the usual traffic before and/or after the time of the meeting, or the actual traffic to attend and/or leave the meeting. In embodiments of the invention, the map 116 is interactive. The recipient may alter the time at which the traffic pattern is shown, or choose a different route altogether. The map 116 may also depict travel via public transport, walking (with walking paths), biking (with biking trails), or any other mode of transport. The map 116 may depict the quickest route, a route that avoids traffic lights, highways, or tolls, any one-way streets, the number of lanes in a certain street, or any other cognizable map feature. The map 116 may be a satellite view, a street view, a 3-D view, an aerial view, a terrain view, an earth view, or any other cognizable map view. In embodiments of the invention, the meetings may be held in different cities or states. If the recipient is traveling via a plane and/or train (including commuter train), the appointment may include any relevant reservation information, and relevant traveler information (i.e., a rewards number). In embodiments of the invention, the meeting sender and/or meeting attendees can be alerted if the traveler checks into their flight or train. If means of travel are delayed, the sender and/or meeting attendees may be alerted of the same. The traveler may be automatically connected with a company's travel agency to ascertain and purchase a different ticket. In other embodiments, the traveler can change their travel plans via electronic means, such as an application on their portable device. Furthermore, the traveler's meeting attendance will automatically update based on any new travel plan. The meeting may optionally be changed if the traveler is going to be late or miss the meeting.

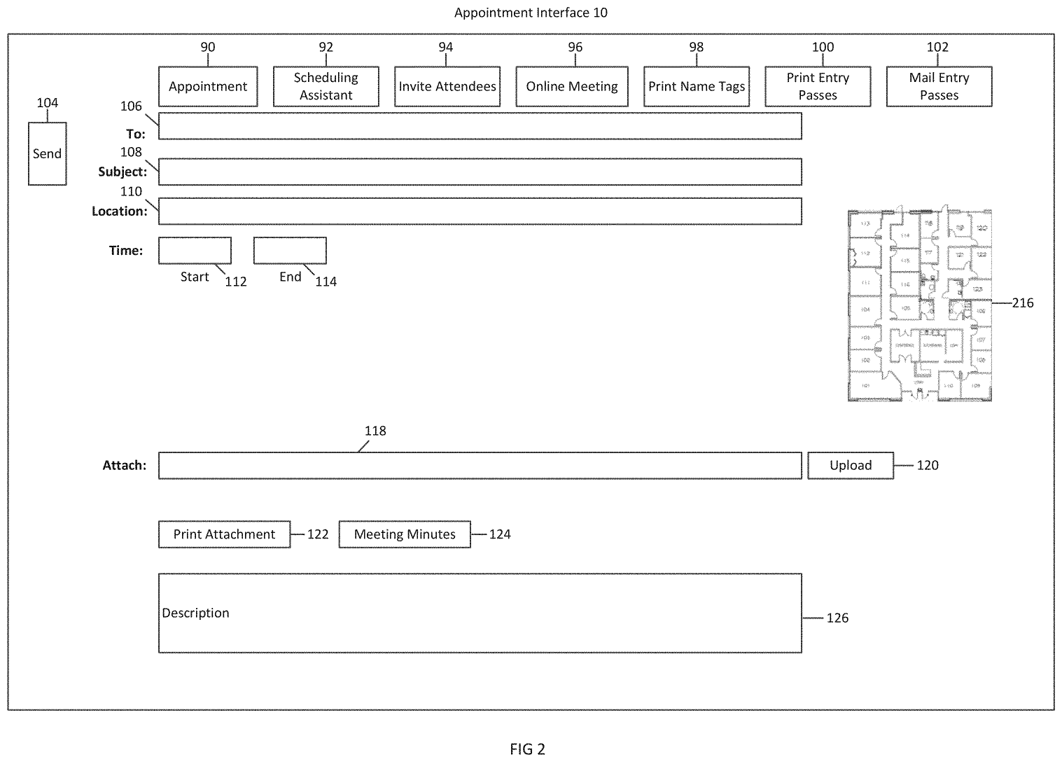

In embodiments of the invention, if a company's building room is inputted into the location field 110, a blueprint 216 (as depicted in FIG. 2) of the floor or building may populate. The blueprint 216 may depict the exact location of the room. A recipient may interact with the blueprint 216 to ascertain the best route to take there.

Attendees may choose to accept the meeting online, over the phone, or in person. For recipients choosing to attend the meeting online, the sender may send a videoconference link, or the appointment interface 10 will automatically populate with one. In embodiments of the invention, the videoconference link will automatically pop-up on the attendee's screen or device at the time of the meeting. If the recipient chooses to attend the meeting over the phone, the sender may send conference call dial-in information, or the appointment interface 10 will automatically populate with one. In embodiments of the invention, at the time of the meeting, the attendee's computer or device will automatically dial into the call. If the recipient chooses to accept the meeting in person, the appointment interface 10 will automatically populate with the map 116 or blueprint 216 with directions to the location in the location field 110 for each attendee. The directions may be either visual, step-by-step, auditory, or a combination thereof. The directions may be integrated with any of the attendee's compatible computing devices (i.e., a cellular device) and populate on that as well.

To customize the directions, map 116, or blueprint 216 for each attendee's location, an attendee may manually enter their physical address or building room number into the location field 110 or system. In other embodiments of the invention, the company may store each employee's address and/or office location in a location database. An employee's office location may include any cubicle, desk, lab, or location where he/she regularly conducts his/her trade. In other embodiments of the invention, the employee's location may be based on Global Positioning System (GPS). If the recipient is not an employee, or whose information is not stored in the database, the recipient's data may be pulled from the company and/or sender's contact list, an email, or any other cognizable service that provides location information (i.e., public record directories). The company may also store blueprints or other maps of the building into the database. The location of the recipient may also be inputted manually.

For recipients who are offsite or not employees of the company's sender, the sender may secure entry passes for the recipients by clicking the print entry passes 100 button. The sender may also mail the entry passes via e-mail, physical mail, or sms message by clicking the mail entry passes 102 button. These may be configured to auto print and/or mail to recipient by the sender at any time. They may also be configured to be a “ticket” in an attendee's wallet or other application on one or more of their computing devices. In embodiments of the invention, the sender can print the entry passes directly to the company's reception for the recipient to pick up upon arrival at the building and use throughout the building, or any other convenient location (i.e., a lobby) where the attendee enters. In embodiments of the invention, the entry pass is linked to the meeting such that it remains active and valid for 30 minutes before and after the meeting, an hour before and after the meeting, or any other time limit as appropriate. In embodiments of the invention, the entry pass allows access to certain designated areas in the building, including, but not limited to, the floor where the meeting will be held, or the room where the meeting will be held. A sender may manually restrict the access of the entry pass, or it may automatically be programmed based on the company's policies.

In embodiments of the invention the sender may indicate a start time for the meeting in the start field 112 and an end time for the meeting in the end field 114. The start time and end time may also automatically populate if the meeting is a repeat, or a part of a series. A sender may upload 120 one or more attachments 118. In embodiments of the invention, any uploaded document may be manually or automatically converted to a readable format for all computing devices. For example, in embodiments of the invention, the uploaded document may be converted to a portable document form (PDF) to be opened and/or viewed on a cellular device or tablet.

In embodiments of the invention, after a meeting, a sender or recipient may attach meeting minutes by clicking and uploading the meeting minutes 124 button. In embodiments of the invention, the completion of uploaded meeting minutes may send an alert to the recipients of the meeting invite. These and any other attachments 118 may be converted as described herein. A user may customize the appointment interface 10 to allow for uploading 120 of any number of files in any format (i.e., audio, video, and document). In embodiments of the invention, the sender may set up an audio and/or video recording of the meeting to be uploaded to the meeting invite. A user or company may customize the appointment interface 10 to include buttons to serve any of their needs. For instance, buttons for printing the map 116, printing the blueprint 216, attaching multiple documents 118, viewing attendees, may all be programmed and included.

In embodiments of the invention, the components of the appointment interface 10 may be adapted even where there is no recipient (i.e., where the sender creates an appointment 90 for him/herself). In other words, a user may create an appointment for a doctor's appointment, for example, and input a start time 112, an end time 114, a subject 108, an address into the location field 110 wherein an interactive map 116 populates with the features described herein, etc. Any number of events may be inputted into the appointment interface 10, wherein any number of the features as described herein may be utilized. In other embodiments of the invention, the appointment interface 10 may be adapted to assist a user with calendar reminders. For example, a user choosing to use the appointment interface 10 to remind themselves of a deadline for a certain task delegated to them via e-mail, may attach 118 the e-mail in an appointment that they create for themselves, wherein the appointment interface 10 features are equally in force. The appointment interface 10 may be utilized for any number of reminders or tasks, with any of the features described herein.

In embodiments of the invention, entire calendars may be shared with others, subject to any policies of the company. In other embodiments of the invention, a user may have one or more calendars imposed on each other with different privacy policies affiliated with each.

The software comprising the appointment interface may be, for example. Microsoft Outlook, Apple's Mail and Calendar applications, Google's Gmail and Calendar applications. Yahoo's mail and calendar applications, the applications of any internet browser (i.e., Mozilla), or any other cognizable mail and calendar application.

The appointment interface 10 may be accessed and appointments may be created on the internet, or on any computing device connected to a network. The appointments may also be accessed and altered while offline, and will automatically or manually update, as described herein, when connected to a network.

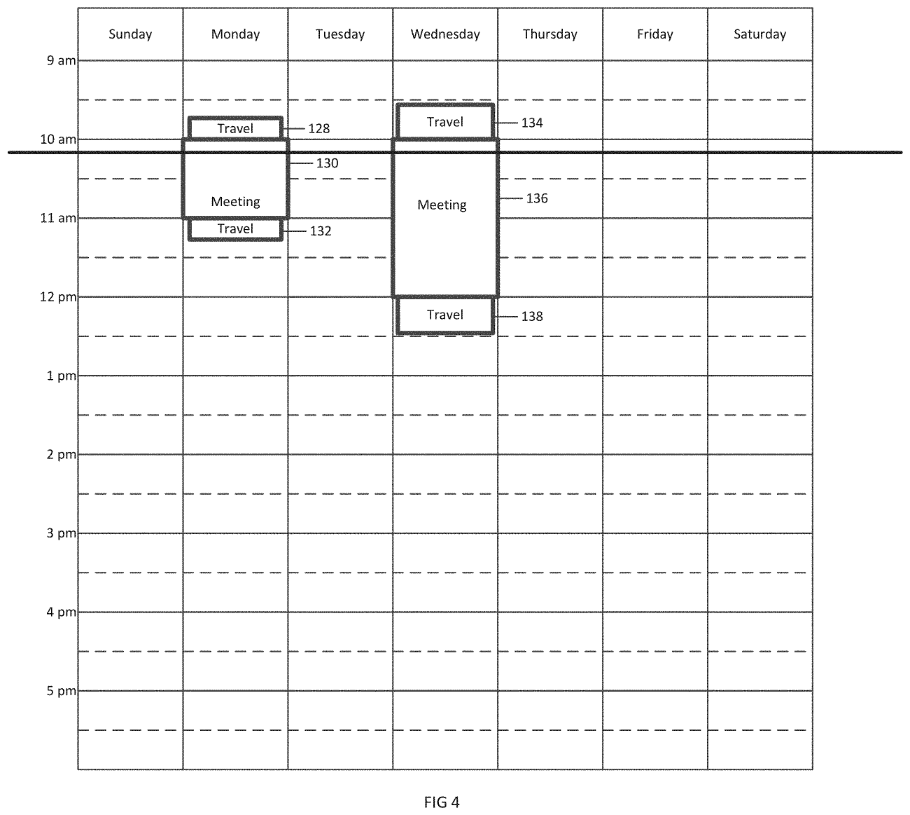

FIG. 4 depicts a week view according to an embodiment of the invention. In embodiments of the invention, a meeting 130 or 136 on a calendar may block out travel time before 128 or 134 and after 132 or 138 the meeting depending on the traffic or travel time to and from the location as described herein. Depending on where the meeting is, the travel time may be short or long. The travel time will account for all relevant factors, such as the time needed to reach a person's car, or the time needed to pack up the attendee's belongings. An attendee may manually input some extra time for travel, or the system may automatically detect this based on patterns of the attendee. Furthermore, the travel time may account for the location of a subsequent meeting, and will automatically update with any new developments in the travel plan. For example, if the travel time 134 to the meeting 136 was 30 minutes but an accident occurred on the route of travel during the meeting, the travel time after the meeting 138 to the next location will automatically update.

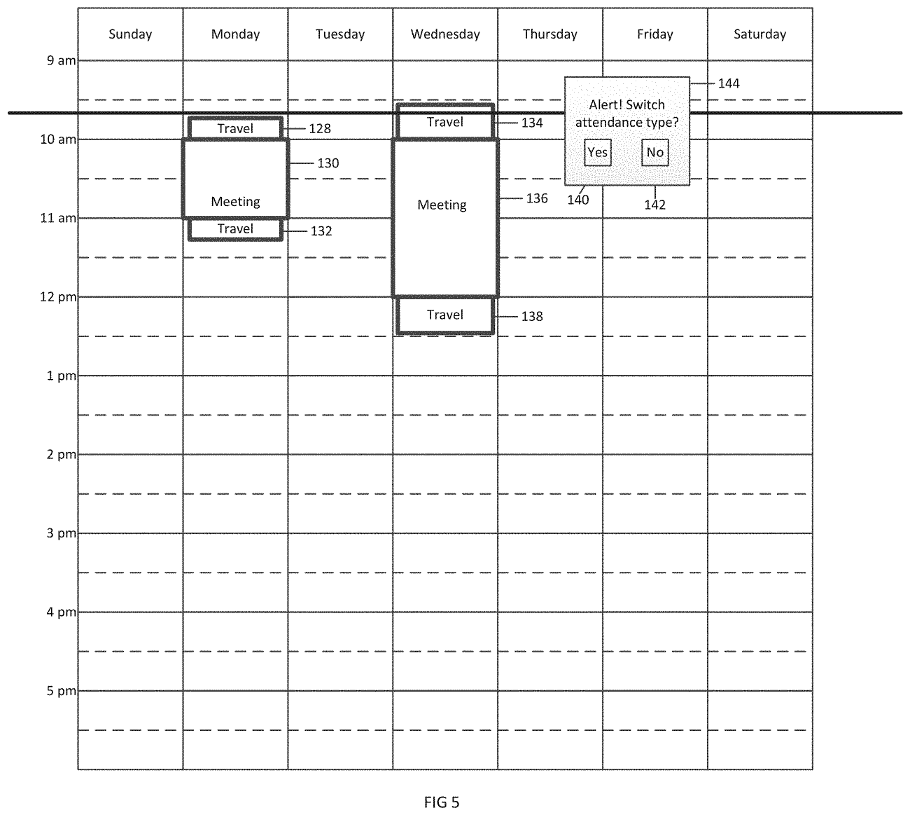

In FIG. 5, an alternate embodiment of the week view, an alert 144 populates if the attendee is running late to the meeting (accounting for the travel time before or after the meeting). If the attendee indicated they would attend the meeting in person, the alert 144 allows an attendee to switch the type of attendance to online, conference call, or any other type of meeting by clicking yes 140 and selecting the type of attendance, or no 142. The change in attendance type may be automatic or manual.

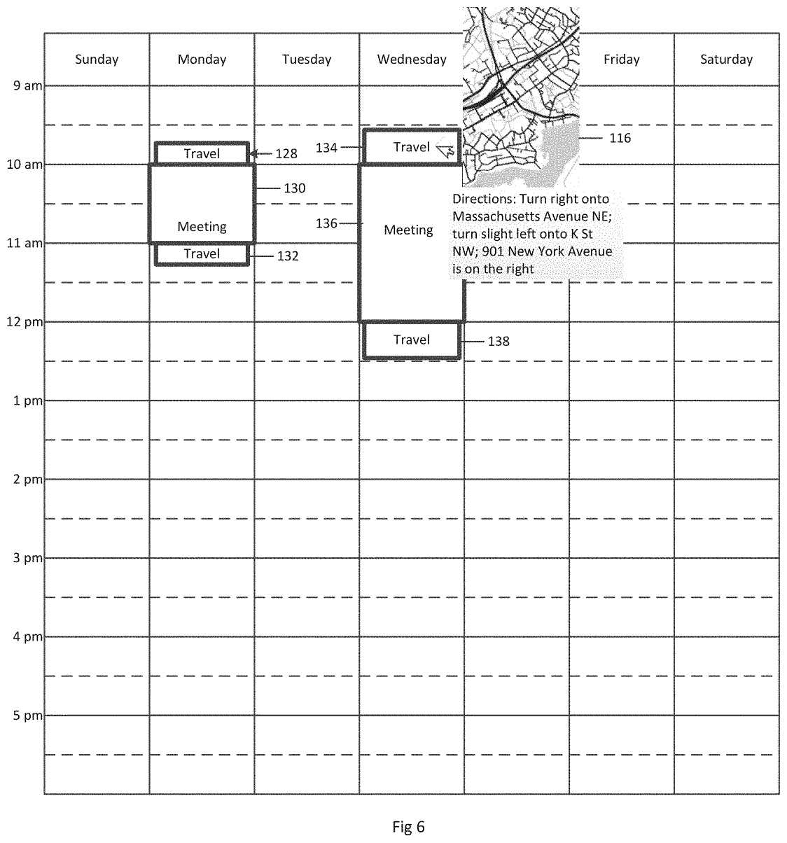

FIG. 6 depicts a week view according to an embodiment of the invention. In this embodiment, an attendee planning to travel to a meeting may hover over the travel block 134 on a computer or select it in another computing device to view the map 116 or blueprint 216 depicting the route to attend the meeting. The map 116 will also populate with directions to attend the meeting, and will automatically update with any changes in traffic advisories, including, for example, public transport delays or obstructions on bike or walk paths.

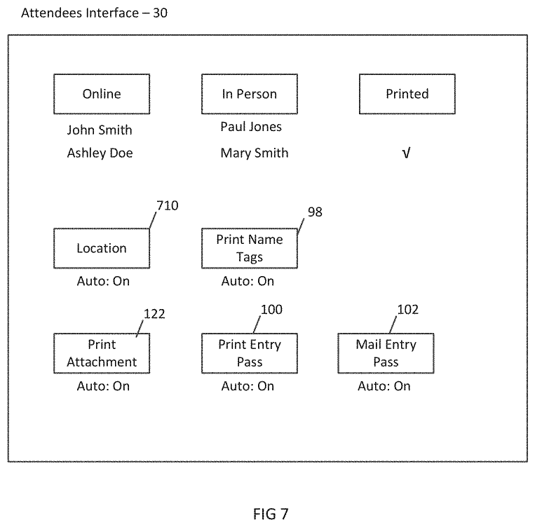

FIG. 7 depicts an attendees interface 30 whereby the sender and/or all recipients may see who is attending the meeting and how. The attendees interface 30 may automatically refresh until a cut-off period designated by the sender or the company or a default. In embodiments of the invention, the attendees interface 30 will depict the attendees who are attending online or via conference, the attendees who are attending in person, and who (of those attending in person) have printed any relevant attachments. This will enable the sender to print the correct number of copies for the in-person meeting, either manually or automatically. In embodiments of the invention, the attachments will automatically print to the room depicted in location 710, or a location convenient for the sender, or any location designated by the sender. In embodiments of the invention, the sender receives a notification of the number of copies of the attachment the meeting recipient has printed. In embodiments of the invention the meeting recipient is alerted, as described herein, if an updated copy of an attachment has been uploaded. Recipients are able to select the print attachment 122 button to print the newly updated document, without re-printing the other attachments. A recipient may also select one or more attachments for printing at any time.

In embodiments of the invention, the location 710 will automatically update to accommodate the number of in-person attendees (in case people switch or the room chosen is improperly sized), so as to conserve resources. Any change in the room will automatically update the calendar invite with the proper location, and update the travel time and all other features as described herein. An alert may be sent to any recipients of the room change. Typically, the location 710 will only automatically be changed the day of the meeting, but in certain embodiments of the invention the location 710 may adjust based on any time interval. In embodiments of the invention, the name tags for the in-person attendees will automatically print to the room depicted in location 710, or a location convenient for the sender, or any location designated by the sender. In embodiments of the invention, the name tags and attachments will be printed or mailed within 30 minutes of the meeting to a location convenient for the sender. The entry passes may be printed or mailed within 30 minutes in a location convenient for the attendee, or locations as described herein. In other embodiments, the name tags and attachments will be printed or mailed, and the entry passes may be printed or mailed within an hour of the meeting. A sender or company may change the cut-off time for printing and/or mailing of any and all documents at any time period before the meeting. All automatic actions may also be completed manually (the automatic feature may be turned off).

In embodiments of the invention, a sender may choose to order food and/or beverages or other items for the meeting. The sender may alter the appointment interface 10 to include an option for ordering food and/or beverages. The food and/or beverages may be ordered manually, or automatically based on a cut-off time designated by the sender or a default set. In an embodiment of the invention, selecting a lunch meeting will automatically provide the sender (and optionally recipients) with menus from local establishments based on the sender's GPS. In other embodiments, the sender (and/or one or more recipients) may select a venue and the items to order and the system will order the correct amount of food based on the number of attendees designated by the cut-off.

In embodiments of the invention, certain meetings will be repeated at the same or similar time on a regular basis. For instance, the same meeting may be held on Mondays at 12 PM. A sender may be able to glean statistics on the method that the attendees select to attend the meeting. For example, a sender may be able to ascertain that John Smith attended the meeting online regularly. These statistics help the sender ascertain metrics on the method of attendance.

In embodiments of the invention, the meetings may be color coded. The color codes may be based on any number of criteria set by the sender or the recipient, including, for example, based on the project, meeting type, sender, keyword, the people in attendance, or hashtag. Persons of ordinary skill can ascertain the various methods by which appointments and/or meetings may be coded. In embodiments of the invention, series of events may be color coded similarly. In other embodiments of the invention, the sender and recipients may set any number of rules for the colors. In other embodiments of the invention, the coding may correspond to colors of e-mails.

In embodiments of the invention the meetings may be searchable. For example, meetings may be searched or filtered by title, attendee (i.e., all meetings that an attendee attended), sender, project, etc. In embodiments of the invention, only the meetings fitting the search terms will populate. In other embodiments, the meetings fitting the search term will be highlighted, or color-coded, or visually depicted in a manner that draws attention to those meetings.

These adaptations may also be used for personal, instead of business use. All features are available on any computing device, including, but not limited to, a cellular device and/or tablet. Any and all features may be compatible with any built-in personal assistant software, such as, for example, Siri used on Apple computing devices.

Any alert as described herein may be a pop-up alert in the mail or calendar client, e-mail to attendees, a meeting calendar alert, or any other form of alert on any computing device. Many (or all) of the features are co-dependent. So for example, if a person is running late for a meeting and switches to attending the meeting online, the number of copies of attachments that need to be printed, the name tags, and any relevant entry passes will also be simultaneously changed. Persons of skill in the art would easily ascertain the numerous co-dependencies described herein. All automatic action may be completed manually, and vice versa.

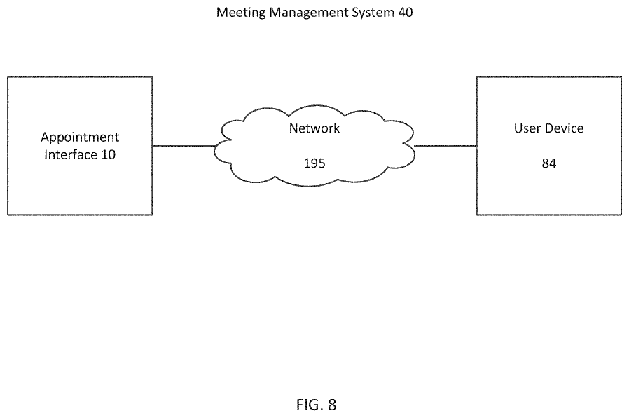

FIG. 8 is a block diagram illustrating an operating environment for a server-based meeting management system 40. The meeting management system 40 includes an appointment interface 10 connected through a communications medium over a network 195, such as for example, but not limited to, the Internet, an Intranet, a local-area-network (LAN), a wide-area-network (WAN), etc., to a user device 84 and/or one or more company systems (such as, for example, the events management system and/or food and beverage system, and/or information technology system as described herein).

The network 195 is preferably the Internet, but may be or include other types of networks. The network 195 may include a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

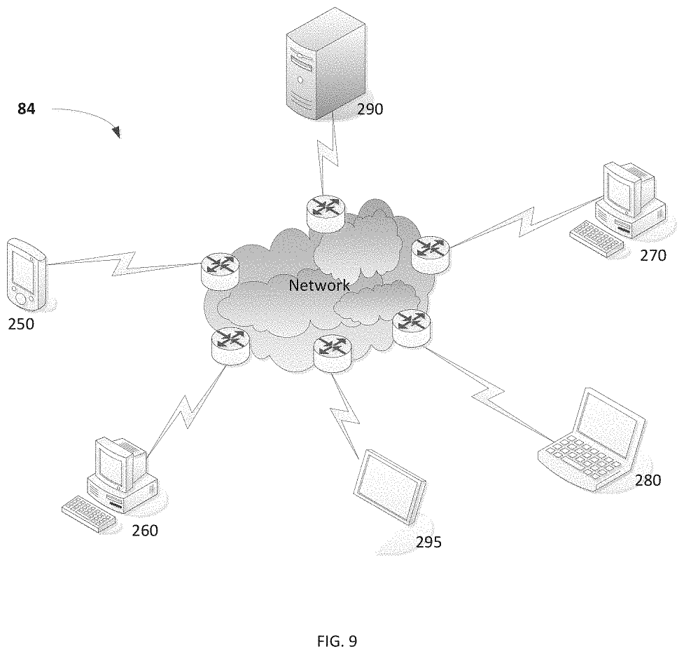

FIG. 9 is a block diagram illustrating an operating environment for a Meeting Management System 40 in accordance with an embodiment of the invention. Those skilled in the art will appreciate that the invention may be practiced with various computer system configurations, including hand-held wireless devices such as mobile phones, smart phones or Personal Digital Assistants (PDAs) 250, multiprocessor systems 260, microprocessor-based or programmable consumer electronics 270, minicomputers 280, mainframe computers 290, Tablets (iPad™, Samsung Galaxy™, etc.) 295, and the like. The invention may also be practiced in distributed computing environments where tasks are performed by remote processing devices that are linked through a communications network. In a distributed computing environment, program modules may be located in both local and remote computer storage media including memory storage devices.

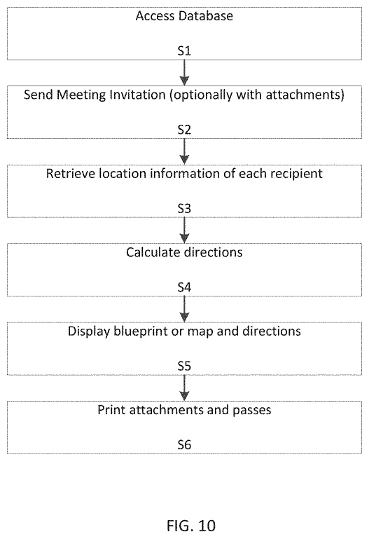

FIG. 10 is a process flow diagram according to an embodiment of the invention. In an embodiment of the invention, a server comprises a nontransitory computer memory storing instructions and a processor for executing the stored instructions and performing steps including accessing a database to retrieve one or more recipients' contact information (S1); sending a meeting invitation for a meeting, over a communication network, from a user device, wherein the meeting invitation information includes at least identification of one or more recipients, a time range for the meeting, a subject for the meeting, and a location for the meeting (S2); for each recipient, communicating with at least one database to retrieve location information (S3), and calculating directions to the meeting location based on the recipient's contact information (S4); transmitting, over the communication network, to the user device, the calculated directions, and displaying at least one of a map or blueprint and the directions for the recipient to the meeting location (S5). In embodiments of the invention, the meeting invitation may comprise attachments as described herein, which can be printed (S6). The attachments may be physically printed, or converted for viewing on the user device (as described herein). In embodiments of the invention, the meeting invitation may be sent to external recipients for which entry passes may be printed (S6). In embodiments of the invention, the map or blueprint is interactive.

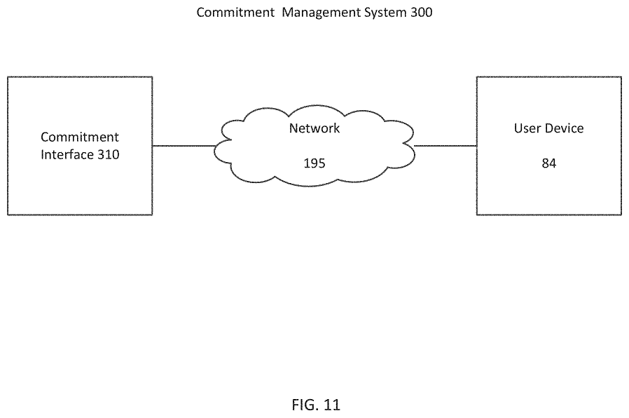

FIG. 11 is a block diagram illustrating an operating environment for a server-based commitment management system 300. The commitment management system 300 includes a commitment interface 310 connected through a communications medium over a network 195, such as for example, but not limited to, the Internet, an Intranet, a local-area-network (LAN), a wide-area-network (WAN), etc., to a user device 84 and/or one or more company systems (such as, for example, the events management system and/or food and beverage system, and/or information technology system as described herein). The network 195 and user device 84 are as described herein.

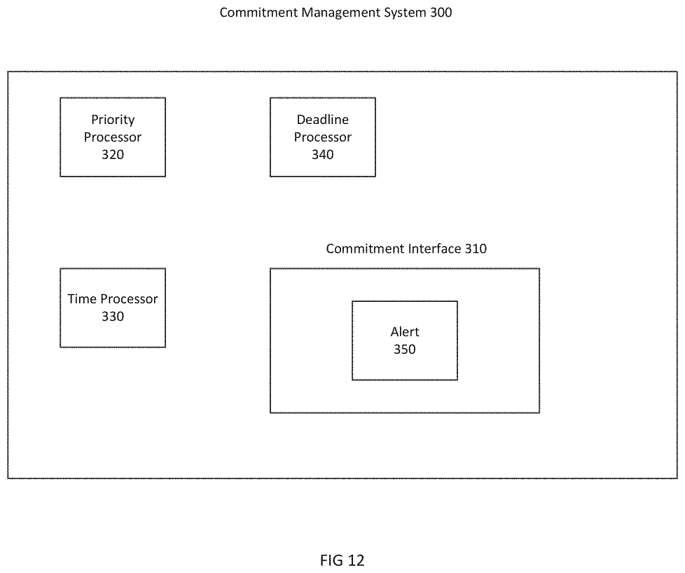

FIG. 12 is a block diagram illustrating an embodiment of the commitment management system 300. The commitment management system 300 is capable of ascertaining a recipient's availability to complete one or more particular tasks. The one or more tasks may arrive for a recipient via, for example, e-mail, phone call, personal visit, snail mail, SMS-message, or video call/message. Persons of ordinary skill would recognize the various ways in which a task may be received. In embodiments of the invention, a recipient's e-mail asking for completion of a task may delineate a deadline, priority, and time requirement. For example, the e-mail may ask for completion of a high-priority task by a certain date requiring 10 working hours. In embodiments of the invention, the task is automatically captured by the commitment interface. In other embodiments of the invention, the recipient may transfer or enter the various requirements into the commitment interface.

In embodiments of the invention, the priority may be automatically set by the hierarchy of the company. For example, if a recipient's boss sends an email with a task, the priority will automatically be higher than another task not from the recipient's boss. The company's organization hierarchy may be input into a hierarchy database with an accompanying processor capable of processing a sender's place in the hierarchy. In other embodiments of the invention, the priority of a task will be set by, for example, the deadline, the client, or the sender. Persons of ordinary skill would understand the various factors that weigh into the priority of the assignment.

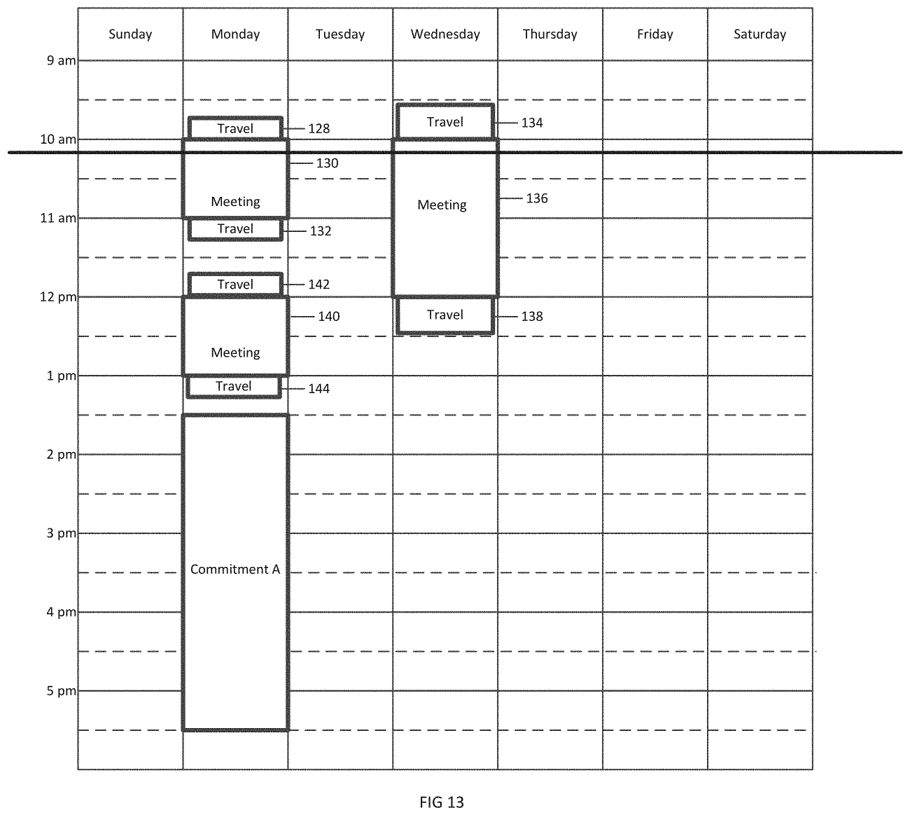

Once a task is in the commitment management system 300, a priority processor 320 works in conjunction with a time processor 330 and a deadline processor 340 to properly allot the recipient's working availability and communicate, using the alert 350 on the commitment interface, whether the recipient will be able to meet a deadline. The priority processor 320 ascertains the various priorities associated with the various tasks a recipient has. The deadline processor 340 ascertains the various deadlines affiliated with the various tasks a recipient has. The time processor 330 ascertains the amount of time each task will take to complete. In embodiments of the invention, if a person has the time to complete the task by the deadline, the alert will notify the recipient so. In other embodiments, if a person does not have the time to complete the task by the deadline, they will be alerted so. The recipient then has the option to communicate with the senders of other tasks to move the deadline. This communication may alternatively be automatic. In embodiments of the invention, a recipient is able to track the amount of time spent, and how much time is remaining to complete the commitment. In other embodiments, the system will alert the recipient if they will not be able to complete the commitment in time.

Where a recipient is alerted that they have time to complete the task by the deadline, the task may be conformed to a recipient's commitment. Visually, blocks of available time are marked on the recipient's calendar, for the time duration of the commitment by the deadline (See FIG. 13). For example, if a recipient has 2 meetings and a commitment A that requires 4 hours for completion, a “commitment A” will populate on the calendar. An exemplary embodiment of this is shown on FIG. 14. Commitments do not need to be on consecutive blocks of time. For example, if a recipient has 2 hours between meetings, the commitment management system 300 will break up the commitment into two 2-hour blocks during the day. In embodiments of the invention, the commitment management system 300 is smart, and therefore will properly account for bathroom breaks, breaks to check e-mail, and other tasks that may cut away from a person's time to work on a certain commitment. The smart commitment management system 300 is also capable of receiving input from the recipient. For example, if a task is taking longer than expected, the commitment management system 300 will automatically move commitments around based on priority or other issues that come up. A recipient may also manually input additional time into the commitment allotment if they anticipate needing additional time. If a deadline is quickly approaching but the recipient hasn't utilized the allocated time to timely uphold their commitment, an alert may notify the recipient of the upcoming due date. In embodiments of the invention, the alert may also notify the sender.

The calendar is capable of showing the various commitments a recipient is managing, and therefore visually allows them to ascertain how their resources are being used. A sender may also be able to see a recipient's calendar view and ascertain whether their task will be completed by the deadline. In other embodiments of the invention, the sender may receive updates regarding the probability the task will be timely completed.

In embodiments of the invention, the amount of committed time spent on a task can be tallied and reported. For example, if a person commits and spends 4 hours on a task, those 4 hours can be automatically reported to be billed to the client. This avoids the need for an employee to track or ascertain the amount of time spent on a certain assignment. Furthermore it eliminates any under or over reporting of time spent. In embodiments of the invention, the committed time can be automatically or manually affiliated with, for example, a project, client, or internal code.

The commitments on a calendar may be color-coded as described herein. In embodiments of the invention, the color-coding may also be based on, for example, priority, time commitment, project, sender, client, type of task, or deadline. Persons of ordinary skill can ascertain the various factors that may weigh into the color-scheme of a calendar appointment.

In embodiments of the invention, for repeat tasks, the smart commitment management system 300 will learn how long a certain task takes an employee, and automatically assign a priority, time, and deadline to it. Persons of ordinary skill can ascertain the various tasks that may implicate these general parameters. In other embodiments of the invention, the smart commitment management system 300 will scan the calendar of the recipient and anticipate the various tasks that may be a commitment for a recipient. It will alert the recipient of these commitments prior to committing to any other tasks. Vacation and personal appointments may also be inputted as commitments.

Various tasks may require meeting management as described herein. For example, a task recipient who must complete employee evaluations must also ascertain the reviewee's availability, and book a room. Persons of ordinary skill would understand the various tasks that may require meeting management as well. The task management aspect of the commitment management system 300 integrates with the meeting management system 40 as described herein.

Additionally, rather than viewing the calendar in the person's calendar application, a person's calendar may be placed as a widget on a person's desktop.

Generally, it should be noted that the components depicted and described herein above may be, or include, a computer or multiple computers. Although the components are shown as discrete units, all components may be interconnected or combined. The components may be described in the general context of computer-executable instructions, such as program modules, being executed by a computer. Generally, program modules include routines, programs, objects, components, data structures, etc., that perform particular tasks or implement particular abstract data types.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system of platform.

At minimum, the memory includes at least one set of instructions that are either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. A computer may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

In addition, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processors and/or memories may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communication protocols may include TCP/IP, UDP, or OSI, for example. For wireless communications, communications protocols may include Bluetooth, Zigbee, IrDa or other suitable protocol. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

It should also be readily apparent to one of ordinary skill in the art that the presently disclosed invention may be implemented in a wide range of industries. The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described above can be made without departing from the spirit and scope of the invention. Accordingly, such modifications are considered within the scope of the invention as intended to be encompassed by the following claims and their legal equivalent.

From the foregoing, it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A server-based meeting management system for seamlessly managing a meeting, the system comprising:
a server comprising:
a nontransitory computer memory storing instructions;
a processor executing the stored instructions in the computer memory, and performing steps including:
accessing a database to retrieve contact information and calendar information for a plurality of recipients;
sending a meeting invitation for a meeting, over a communication network, from a sending user device for a meeting organizer, wherein the meeting invitation information includes at least an identification of one or more of the plurality of recipients, a time range for the meeting, a subject for the meeting, and a location for the meeting;
for each identified recipient, determining a recipient location by communicating with at least one database to retrieve location information, and calculating directions to the meeting location from the recipient location;
transmitting, over the communication network, to a recipient user device for each identified recipient, the calculated directions, and at least one of a map or blueprint and the directions for the recipient to the meeting location, wherein the map includes actual traffic patterns of a route the recipient would take to attend the meeting and to leave the meeting;
wherein the at least one of a map or blueprint is interactive and the locations for the meeting and the directions are integrated with the user's mobile or tablet personal assistant software.

2. The system of claim 1, wherein the map contains driving, walking, or biking directions.

3. The system of claim 1, wherein the map displays driving, walking, or biking paths.

4. The system of claim 1, wherein the user uploads one or more attachments.

5. The system of claim 4, wherein the processor receives the uploaded attachment and displays it for printing by one more recipients.

6. The system of claim 5, wherein the user is notified if one or more recipients prints each of the one or more uploaded attachments.

7. The system of claim 1, wherein the directions may be step-by-step, auditory, or visual.

8. (canceled)

9. The system of claim 1, wherein the processor has the contact information for all recipients.

10. The system of claim 1, wherein the user is alerted if one or more recipients is in a different time zone.

11. The system of claim 1, wherein the subject can be audio, video, or text.

12. The system of claim 1, further comprising a printing engine, wherein one or more entry passes, one or more attachments, and one or more name tags are printed or mailed for each of the recipients who have accepted the meeting invitation.

13. The system of claim 1, further comprising a location engine, wherein the location engine reviews the number of recipients who have accepted the meeting invitation and changes the location based on the number of attendees.

14. The system of claim 1, wherein a weekly display of a recipients' meetings includes travel time in addition to the time of the accepted meeting

15. A computer-implemented method of seamlessly managing a meeting, the method comprising:
accessing a database to retrieve contact information and calendar information for a plurality of recipients;
sending a meeting invitation for a meeting, over a communication network, from a sending user device for a meeting organizer, wherein the meeting invitation information includes at least an identification of one or more of the plurality of recipients, a time range for the meeting, a subject for the meeting, and a location for the meeting;
for each identified recipient, determining a recipient location by communicating with at least one database to retrieve location information, and calculating directions to the meeting location from the recipient location;
transmitting, over the communication network, to a recipient user device for each identified recipient, the calculated directions, and at least one of a map or blueprint and the directions for the recipient to the meeting location wherein the map includes actual traffic patterns of a route the recipient would take to attend the meeting and to leave the meeting;
wherein the at least one of a map or blueprint is interactive and the locations for the meeting and the directions are integrated with the user's mobile or tablet personal assistant software.

16. The method of claim 15, wherein the map contains driving, walking, or biking directions.

17. The method of claim 15, wherein the map displays driving, walking, or biking paths.

18. The method of claim 15, wherein the user uploads one or more attachments.

19. The method of claim 18, wherein the meeting processor receives the uploaded attachment and displays it for printing by one more recipients.

20. The method of claim 19, wherein the user is notified if one or more recipients prints each of the one or more uploaded attachments.

21. The method of claim 15, wherein the directions may he step-by-step, auditory, or visual.

22. (canceled)

23. The method of claim 15, wherein the database has the contact information for all recipients.

24. The method of claim 15, further comprising a printing engine, wherein one or more entry passes, one or more attachments, and one or more name tags are printed or mailed for each of the recipients who have accepted the meeting invitation.

25. The method of claim 15, further comprising a location engine, wherein the location engine reviews the number of recipients who have accepted the meeting invitation and changes the location based on the number of attendees.

26. The method of claim 15, wherein a weekly display of a recipients' meetings includes travel time in addition to the time of the accepted meeting.

27. The method of claim 15, wherein the user is alerted if one or more recipients is in a different time zone.

28. A device for seamlessly managing a meeting, comprising:
an input device to enter meeting invitation information for a meeting from a user, wherein the meeting invitation information includes identification of at one or more recipients, a time range for the meeting, a subject for the meeting, and a location for the meeting;
a communication unit to transmit the meeting invitation information to a server and to receive at least one of a map or blueprint and instructions for the meeting from the server: and
a display to display the at least one of a map or blueprint and instructions.

29. A server-based commitment management system for seamlessly managing one or more commitments, the system comprising:
a server comprising:
a nontransitory computer memory storing instructions;
a database with a company's organizational hierarchy;
a database with one or more recipients' tasks;
a priority processor executing the stored instructions in the computer memory, and assigning a priority to a task, wherein the priority of the task is based a task requestor's place in the company's organizational hierarchy, a deadline for the task, and an analysis of the task:
a time processor executing the stored instructions in the computer memory, and assigning a time amount to a task;
a deadline processor executing the stored instructions in the computer memory, and assigning a deadline to a task;
for each task, determining if a recipient has capacity to perform the task by the assigned deadline;
for each task, transmitting over a communication network, to a user device, an alert notifying the user of the task, the assigned priority, time, deadline, and whether the user will have capacity to complete the task by the assigned deadline on a commitment interface;
wherein the commitment interface is interactive.
